(19) United States
(12) Patent Application Publication
(10) Pub. No.: US 2004/0012891 A1
(43) Pub. Date: Jan. 22, 2004

(54) FPC mounting apparatus

(76) Inventors: Masao Habe, Chiba-shi (JP); Matoji Amakura, Chiba-shi (JP); Eiji Nakano, Chiba-shi (JP); Kouichi Tazaki, Chiba-shi (JP)

Correspondence Address: ADAMS & WILKS, 31st Floor, 50 Broadway, New York, NY, 10004, US

(21) Appl. No.: 10/306,692

(22) Filed: Nov. 27, 2002

(30) Foreign Application Priority Data
Dec. 4, 2001 (JP) 2001-369914

(51) Int. Cl. G11B 5/55

(52) U.S. Cl. 360/264.2

(57) ABSTRACT

To provide an FPC mounting apparatus for automatically mounting an FPC within a holding portion formed in a carriage arm of a carriage, an FPC can be automatically mounted within a holding portion by an FPC mounting apparatus provided with push-in means for pushing the FPC into the holding portion and mounting it therein. In addition, guiding means is provided, the FPC is guided from both sides in the thickness direction, and the FPC can be mounted within the holding portion more securely. Furthermore, by using an FPC mounting apparatus provided with engaging means for engaging an engaging portion after the FPC, which is provided with the engaging portion, is moved in a relative manner and made to deflect while in a state of being sandwiched and held from both sides in the thickness direction, then released from the sandwiched-and-held state and allowed to elastically recover, it becomes possible to perform work for automatically mounting the FPC in a state in which it is engaged with the carriage while being prevented from falling off from the holding portion.

### BACKGROUND OF THE INVENTION

The present invention relates to an FPC mounting apparatus for mounting an FPC, formed integrally with a magnetic head, within a holding portion formed in a carriage arm of a carriage.

Hard disk drives mounted in computers, video decks, and the like have magnetic heads for performing at least one operation, either the writing in of data, or the reading out of data. The magnetic head is provided for the hard disk drive in a state in which it is attached to a carriage as a single structural element of an HGA (head gimbal assembly).

A carriage 200 is provided with a plurality, of carriage arms 210 arranged at a predetermined spacing as shown in FIG. 1, and an HGA 300 (magnetic head) is attached to a tip portion of the carriage arms 210. There are cases in which an FPC (flexible printed circuit) 370 is provided to the HGA 300 as a wiring board having flexibility.

Work to be performed on the carriage 200 includes, for example, work for positioning an insertion through hole 360 of the HGA 300 in a caulking hole 220 formed in the carriage arm 210, and work for attaching the FPC 370, already attached to the HGA 300, to a top surface of the carriage 200. The work performed on the carriage 200 is performed by specified work using automation, or by hand.

Incidentally, it is necessary to mount the FPC formed integrally with the magnetic head within a groove (holding portion) formed in the carriage arm of the carriage after the magnetic head is positioned with respect to the carriage, but the FPC is a flexible material, and therefore is not easily handled by automation, and it is difficult to assemble the FPC into the groove formed in the carriage arm.

### SUMMARY OF THE INVENTION

In view of the above problem, an object of the present invention is to provide an FPC mounting apparatus in which work for mounting an FPC within a holding portion formed in a carriage arm of a carriage is automated.

In order to solve the above-described problem, according to the present invention, there is provided an FPC mounting apparatus for mounting an FPC, formed integrally with a magnetic head, within a holding portion formed in a carriage arm of a carriage when the magnetic head is positioned with respect to the carriage,

characterized by including push-in means for pushing the FPC into the holding portion and mounting it therein.

According to the FPC mounting apparatus of the present invention, the FPC can be pushed into the holding portion and mounted therein by using the push-in means. Therefore, the FPC formed integrally with the magnetic head can be automatically mounted within the holding portion formed in the carriage arm of the carriage by the push-in means.

Further, the above-described FPC mounting apparatus is characterized by including guiding means for guiding the FPC from both sides in a thickness direction when pushing the FPC into the holding portion and mounting it therein.

In accordance with an FPC mounting apparatus of the present invention, an FPC can be guided from both sides in a thickness direction by guiding means, and the FPC can be guided by a guiding portion when pushing the FPC into a holding portion and mounting it therein using push-in means. Therefore, the FPC can be mounted more securely when automatically mounting the FPC inside the holding portion formed in the carriage arm when the magnetic head is positioned with respect to the carriage.

According to the present invention, there is provided an FPC mounting apparatus for mounting an FPC, included in a magnetic head, within a holding portion formed in a carriage and in a state of being engaged with the carriage so as to be prevented from falling off from the holding portion, when the magnetic head is positioned with respect to the carriage,

characterized by including engaging means for: moving the FPC, relative to the carriage, to a fixing end side with respect to the magnetic head, with the FPC in a state in which it is sandwiched and held from both sides in a thickness direction, deflecting the FPC and thus moving the FPC so that an engaging portion of the FPC is in a standby position for engaging; and then releasing the FPC from its sandwiched-and-held state, thereby allowing the FPC to elastically recover and the engaging portion to engage with the carriage.

According to the FPC mounting apparatus of the present invention, it is provided with engaging means, whereby an engaging portion of the FPC can be moved, relative to the carriage, to a fixing end side with respect to the magnetic head, with the FPC in a state sandwiched from both sides in a thickness direction. The FPC can be deflected and thus moved so that engaging portion of the FPC is in a standby position for engaging. The sandwiched state of the FPC is then released, allowing the FPC to recover elastically and the engaging portion can be engaged with the carriage. Work for mounting the FPC within the holding portion formed in the carriage in such a state that it is prevented from falling off from the holding portion can thus be performed automatically.

Further, the FPC mounting apparatus of the present invention is characterized by including push-in means for pushing the FPC into the holding portion and mounting it therein when the sandwiched-and-held state of the FPC is released by the engaging means.

According to the FPC mounting apparatus of the present invention, the push-in means is provided, whereby it is possible to push the FPC into the holding portion and mount it therein when the sandwiched-and-held state of the FPC is released by the engaging means. Accordingly, the FPC can be mounted within the holding portion more securely when the FPC is engaged to the carriage by the engaging means.

Further, the FPC mounting apparatus of the present invention is characterized by including pressurizing means for pressing down in a direction so as to prevent the FPC from moving in a direction away from the holding portion when the sandwiched-and-held state of the FPC is released by the engaging means.

According to the FPC mounting apparatus of the present invention, the pressurizing means is provided in a case of engaging the FPC with a carriage, whereby the FPC can be pressed upon in a direction so as to prevent motion of the FPC in a direction away from the holding portion when the engaging means releases a state in which the FPC is sandwiched. Accordingly, the motion of the FPC in the direction away from the carriage is regulated and the FPC can be mounted within the holding portion securely.

Further, an FPC mounting apparatus of the present invention is characterized in that:

the FPC is sandwiched and held by a pair of members for sandwiching and releasing the FPC by mutually approaching toward, and separating from, each other when the FPC is sandwiched and held from both sides in the thickness direction; and

at least one of the pair of members is made of an elastic material capable of elastic deformation.

Such an FPC mounting apparatus is provided with a pair of members for sandwiching and holding, and releasing, an FPC, and therefore the FPC can be sandwiched and held, and released, in accordance with the pair of members mutually moving closer together and separating. Also, at least one of the pair of members is made of an elastic material capable of elastic deformation, whereby changes in the total thickness of the FPC following changes in the number of the FPCs to be sandwiched between the pair of members can be handled.

### BRIEF DESCRIPTION OF THE DRAWINGS

FIG. 1 is a perspective view showing a carriage and a magnetic head used in an embodiment mode of the present invention.

FIG. 2A is diagram showing examples of a state in which an FPC is not mounted in a predetermined position when a position of an HGA is determined.

FIG. 2B is diagram showing examples of a state in which an FPC is not mounted in a predetermined position when a position of an HGA is determined.

FIG. 3A is diagram showing examples of a state in which an FPC is mounted in a predetermined position when a position of an HGA is determined, and a diagram for explaining work for mounting the FPC in the holding portion established on the edge surface of the carriage arm.

FIG. 3B is diagram showing examples of a state in which an FPC is mounted in a predetermined position when a position of an HGA is determined, and is a plan view showing side portions of the substrate 205 of the carriage 200 in the state of part (FIG. 3A)

FIG. 4 is a front view showing an example of an FPC mounting apparatus according to the present invention.

FIG. 5 is a side view in which the FPC mounting apparatus shown in FIG. 4 is seen from the direction of an arrow D.

FIG. 6 is an enlarged view of a guiding portion of the FPC mounting apparatus shown in FIG. 5.

FIG. 7A is diagram for explaining operations in a first embodiment mode of an FPC mounting apparatus, which are process diagrams showing the state of a guiding portion, a push-in portion, and an FPC, and is the diagram that shows the initial state.

FIG. 7B is diagram for explaining operations in a first embodiment mode of an FPC mounting apparatus, which are process diagrams showing the state of a guiding portion, a push-in portion, and an FPC.

FIG. 7C is diagram for explaining operations in a first embodiment mode of an FPC mounting apparatus, which are process diagrams showing the state of a guiding portion, a push-in portion, and an FPC.

FIG. 7D is diagram for explaining operations in a first embodiment mode of an FPC mounting apparatus, which are process diagrams showing the state of a guiding portion, a push-in portion, and an FPC.

FIG. 8A is diagram for explaining operations in a second embodiment mode of an FPC mounting apparatus, which are process diagrams showing the state of a guiding portion, a push-in portion, and an FPC.

FIG. 8B is diagram for explaining operations in a second embodiment mode of an FPC mounting apparatus, which are process diagrams showing the state of a guiding portion, a push-in portion, and an FPC.

FIG. 8C is diagram for explaining operations in a second embodiment mode of an FPC mounting apparatus, which are process diagrams showing the state of a guiding portion, a push-in portion, and an FPC.

FIG. 8D is diagram for explaining operations in a second embodiment mode of an FPC mounting apparatus, which are process diagrams showing the state of a guiding portion, a push-in portion, and an FPC.

FIG. 8E is diagram for explaining operations in a second embodiment mode of an FPC mounting apparatus, which are process diagrams showing the state of a guiding portion, a push-in portion, and an FPC.

FIG. 8F is diagram for explaining operations in a second embodiment mode of an FPC mounting apparatus, which are process diagrams showing the state of a guiding portion, a push-in portion, and an FPC.

FIG. 9A is diagram for explaining operations in the second embodiment mode of the FPC mounting apparatus, which are process diagrams showing the operations of the guiding portion and the push-in portion.

FIG. 9B is diagram for explaining operations in the second embodiment mode of the FPC mounting apparatus, which are process diagrams showing the operations of the guiding portion and the push-in portion.

FIG. 9C is diagram for explaining operations in the second embodiment mode of the FPC mounting apparatus, which are process diagrams showing the operations of the guiding portion and the push-in portion.

FIG. 9D is diagram for explaining operations in the second embodiment mode of the FPC mounting apparatus, which are process diagrams showing the operations of the guiding portion and the push-in portion.

FIG. 9E is diagram for explaining operations in the second embodiment mode of the FPC mounting apparatus, which are process diagrams showing the operations of the guiding portion and the push-in portion.

FIG. 9F is diagram for explaining operations in the second embodiment mode of the FPC mounting apparatus, which are process diagrams showing the operations of the guiding portion and the push-in portion.

### DETAILED DESCRIPTION OF THE PREFERRED EMBODIMENT

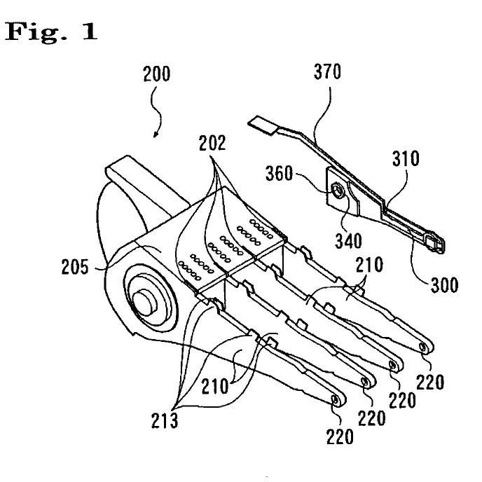

An FPC mounting apparatus according to the present invention is described below with reference to the diagrams. First, an outline of a carriage 200 to be processed in this embodiment mode is explained. The carriage 200 is provided with a plurality of carriage arms 210 arranged at a predetermined spacing as shown in FIG. 1, and an HGA 300 is mounted in the carriage arm 210 by aligning an insertion through hole 360 of the HGA 300 to a caulking hole 220 formed in the carriage arm 210. Further, the carriage arm 210 is provided with groove-shaped holding portion 213 for taking in and holding an FPC 370 that is formed integrally with the HGA 300. The FPC 370 is lastly attached to the carriage 200 by another end portion discussed later, after being stored within the holding portions 213.

The holding portions 213 are provided, for example, with groove portions in a plurality of locations, the groove portions being structured by a pair of wall surfaces protruding from edge surfaces of the carriage arm 210, as shown in FIG. 1. There are cases in which the holding portions 213 are arranged so as to oppose each other, and cases in which they are arranged such that their positions are shifted relative to each other. In addition, although not shown in the figure, consecutive groove portions coupled may also be formed over the entire edge surface of the carriage arm 210, in short, a structure in which the FPC 370 can be inserted and held may also be used.

The FPC 370 is a wiring member in which electric circuits of copper foil etc. are formed on an extremely thin insulating film. For example, the FPC 370 is provided integrally with the HGA 300 by fixing its one end portion to the HGA 300, as shown in FIG. 1, while the other end portion is formed so as to be attached on a substrate 205 provided on the carriage 200.

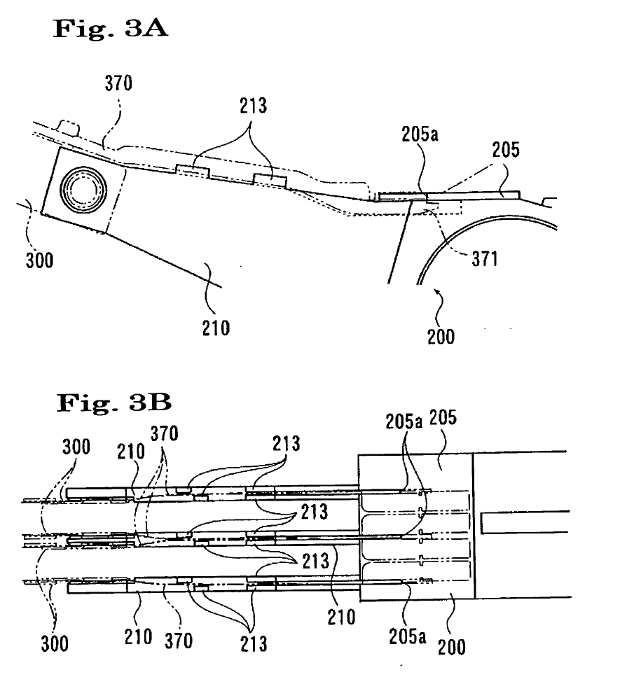

FIGS. 3A and 3B are diagrams showing a state in which the FPC 370 is mounted within the holding portion 213 of the carriage 200, in which part (FIG. 3A) is a diagram for explaining work for mounting the FPC 370 in the holding portion 213 established on the edge surface of the carriage arm 210, and part (FIG. 3B) is a plan view showing side portions of the substrate 205 of the carriage 200 in the state of part (FIG. 3A). That is, when the FPC 370 is in a state of being mounted within the holding portion 213 of the carriage 200, the position in the thickness direction is regulated as shown in FIG. 3B, and the FPC 370 is pushed within the holding portion 213 as shown in FIG. 3A.

In addition, an engaging hook 205a formed in a circumferential portion of the substrate 205 of the carriage 200, and a latching hook 371 (engaging portion) for engaging the engaging hook 205a are formed on the FPC 370. By mounting the FPC 370 within the above-described holding portion 213 in a state in which the latching hook 371 is engaged with the engaging hook 205a, the FPC 370 can be prevented from falling off from within the holding portion 213.

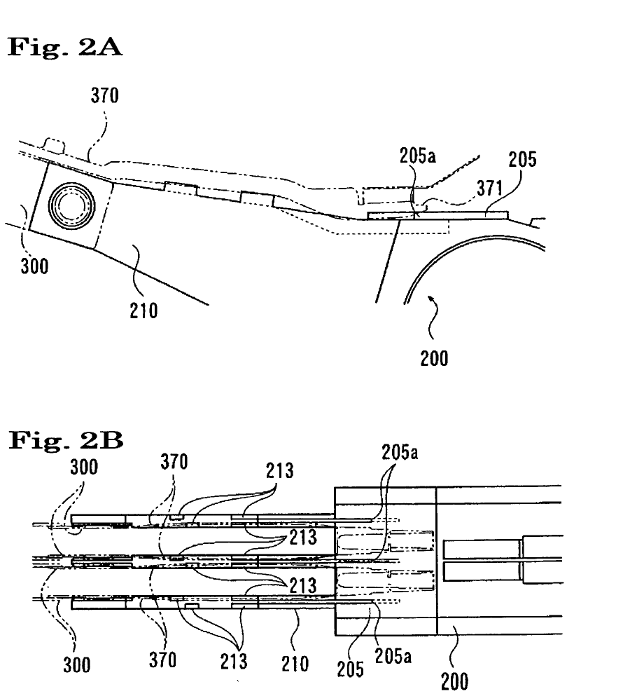

On the other hand, FIG. 2 are diagrams showing an example of a state in which the FPC 370 is not mounted in a predetermined position when a position of the HGA 300 is determined. The FPC 370 is made form a flexible material capable of elastic deformation, and therefore it may float in a position separated form the carriage arm 210 as shown in FIG. 2A, for example, and is not always mounted on the inside of the holding portion 213. That is, the position of the FPC 370 is not determined, for example, as shown in FIG. 2B. Then, the FPC 370 is mounted in the state of FIG. 3 from the state of FIG. 2 by using an FPC mounting apparatus 1 of the present invention.

Note that there are cases in which FPC 370 is provided with the latching hook 371, and cases in which the FPC 370 is not provided with the latching hook 371. First, an example of mounting the FPC 370 to the carriage arm 210 for a case where the latching hook 371 is not formed on the FPC 370 is explained.

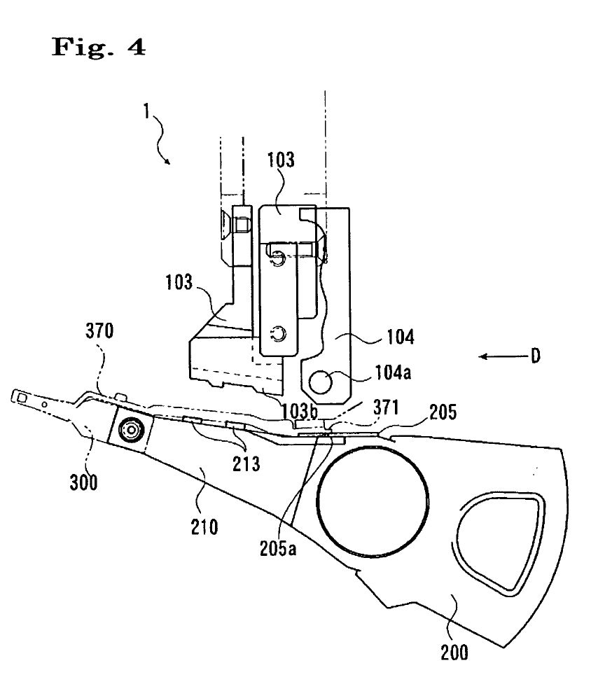

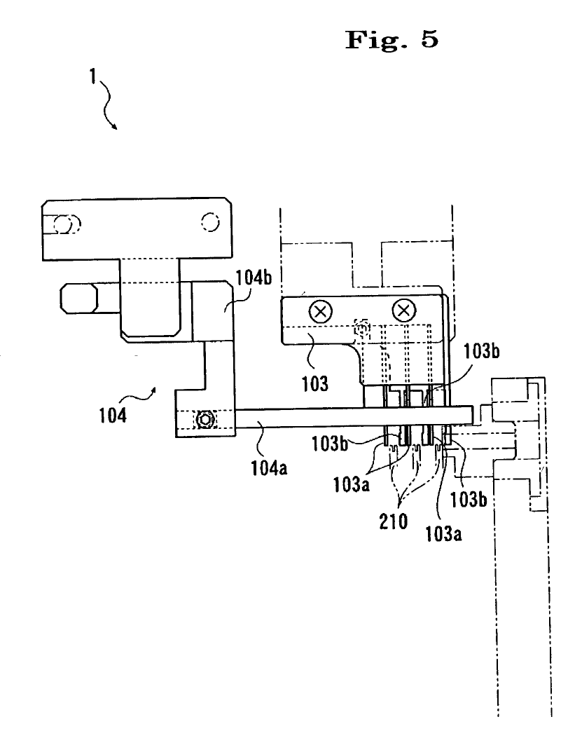

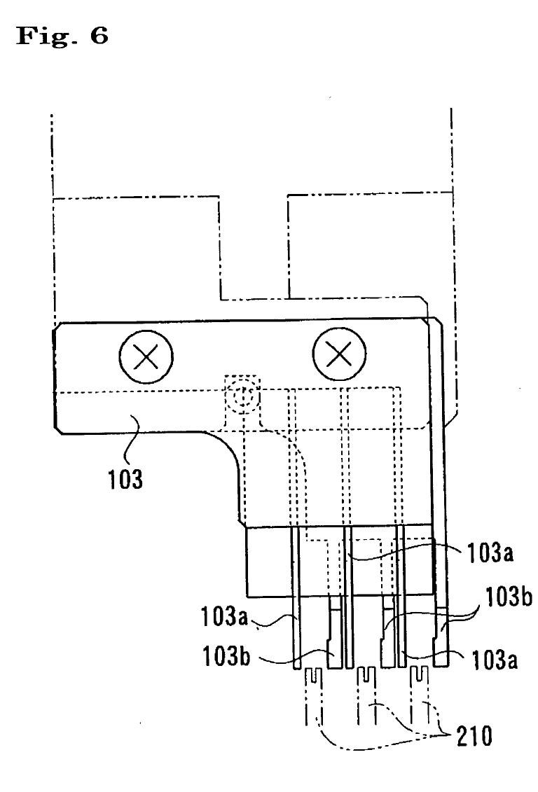

FIG. 4 is a front view showing a first embodiment mode of an FPC mounting apparatus according to the present invention. Further, FIG. 5 is a diagram in which the FPC mounting apparatus shown in FIG. 4 is seen from the direction of an arrow D, and FIG. 6 is a partially enlarged view of a guiding portion 103 (guiding means) shown in FIG. 5. The FPC mounting apparatus 1 of this embodiment mode has its main portions structured by a push-in portion 104 (push-in means) for pushing the FPC 370 into the holding portion 213 and mounting it therein, and the guiding portion 103 for guiding the FPC 370 from both sides in the thickness direction when the push-in portion 104 pushes the FPC 370 into the holding portion 213.

Note that the carriage 200 is held, for example, as shown in FIG. 4 and FIG. 5, such that the holding portion 213 formed in the carriage arm 210 is upwardly arranged and the FPC mounting apparatus 1 is disposed in accordance with the position at which the carriage 200 is held.

The guiding portion 103 is provided with, for example, as shown in FIG. 5 and FIG. 6, a pair of members (a first guiding portion 103a and a second guiding portion 103b) for guiding and releasing the FPC 370 by mutually approaching toward, and separating from, each other, and one of the pair of members 103a and 103b, for example, only the member 103a, is made from an elastic material capable of elastic deformation while the other member, for example, the member 103b, is made from a rigid material.

The push-in portion 104 is structured by a presser 104a for pressing directly onto the FPC 370 and a base portion 104b to which the presser 104a is affixed, and the push-in portion 104 can move freely in a direction approaching toward and separating from the carriage 200.

Next, operation of the FPC mounting apparatus in this embodiment mode is explained. The carriage 200 is provided with three carriage arms 210, for example, as shown in FIG. 2B. From among the three carriage arms 210, the HGA 300 is positioned and attached to the inner side surfaces of tip portions of the two carriage arms 210 and 210 at both ends, and the HGA 300 is positioned to both side surfaces of the carriage arm 210 located in the center. In this state, the FPC 370 is not yet mounted in the holding portion 213, as shown in FIG. 2, for example.

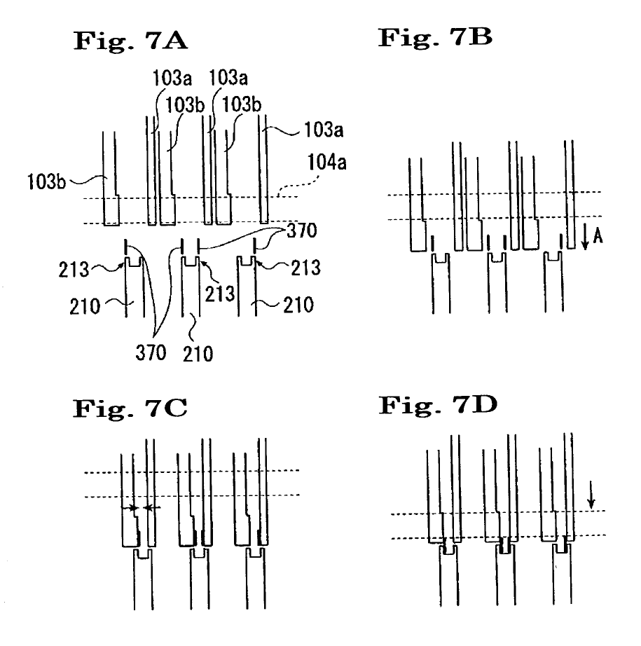

The FPC 370 in this state is mounted within the holding portion 213 by first guiding the FPC 370 from both sides in the thickness direction using the guiding portion 103. That is, for example, from the initial state as shown in FIG. 7A, the pair of members 103a and 103b approach the carriage 200 side (arrow A direction), to a position where the FPC 370 must be guided, in a state in which the pair of members 103a and 103b are separated, as shown in FIG. 7B. Then, for example, as shown in FIG. 7C, the pair of members 103a and 103b approach each other and stop respectively when attaining a distance equal to the distance between the opposing inner side surfaces of the holding portion 213 of the carriage arm 210. Thus, the horizontal position of the FPC 370 is regulated between the inner side surfaces of the holding portion 213. That is, the FPC 370 is in a state of being guided by the guiding portion 103.

Next, the FPC 370 thus guided by the guiding portion 103 is pushed into the holding portion 213 and mounted there. That is, as shown in FIG. 7D, for example, the push-in portion 104 approaches the carriage 300 side, and the FPC 370 is pushed into the inside of the holding portion 213 and mounted there by the presser 104a provided to the push-in portion 104. Note that the presser 104a is designed at this point to have a weight which will not cause deformation and the like in the FPC 370, and which is sufficient to press down on the FPC 370.

In accordance with the FPC mounting apparatus 1 of the above-described embodiment mode, when the HGA 300 is in a state of being positioned with respect to the carriage 200, the FPC 370 can be pushed within the holding portion 213 and mounted there by using the push-in portion 104. Then, when pushing and mounting the FPC 370 within the holding portion 213 by the push-in portion 104, the FPC can be guided from both sides in the thickness direction by the guiding portion 103. Therefore, work for mounting the FPC 370 that is formed integrally with the HGA 300 within the holding portion 213 formed in the carriage arm 210 of the carriage 200 can be performed automatically.

Note that, although the push-in portion 104 uses a structure for pushing the FPC 370 by the presser 104a for pressing on the FPC 370 near the base portion of the carriage arm 210, there are no limitations placed on the shape of the presser 104a or the position to be pressed.

Furthermore, although the guiding portion 103 uses a structure for guiding in which the pair of members 103a and 103b approach each other, the guiding portion 103 is not limited to this structure, in short, it may be a structure so long as the FPC is guided from both sides in the thickness direction.

Next, an example of a second embodiment mode of an FPC positing apparatus relating to the present invention is explained. In this embodiment mode, by using the FPC mounting apparatus 1, the FPC 370 on which a latching hook 371 is formed is mounted within the holding portion 213 formed on the carriage 200, and the latching hook 371 is latched to an engaging hook 205a formed in the circumferential portion of the substrate 205 of the carriage 200. Note that in the second embodiment mode, the pair of members 103a and 103b structuring the guiding portion 103 in the first embodiment mode function as engaging means of the present invention, and the push-in portion 104 functions as both the push-in means and the pressurizing means of the present invention.

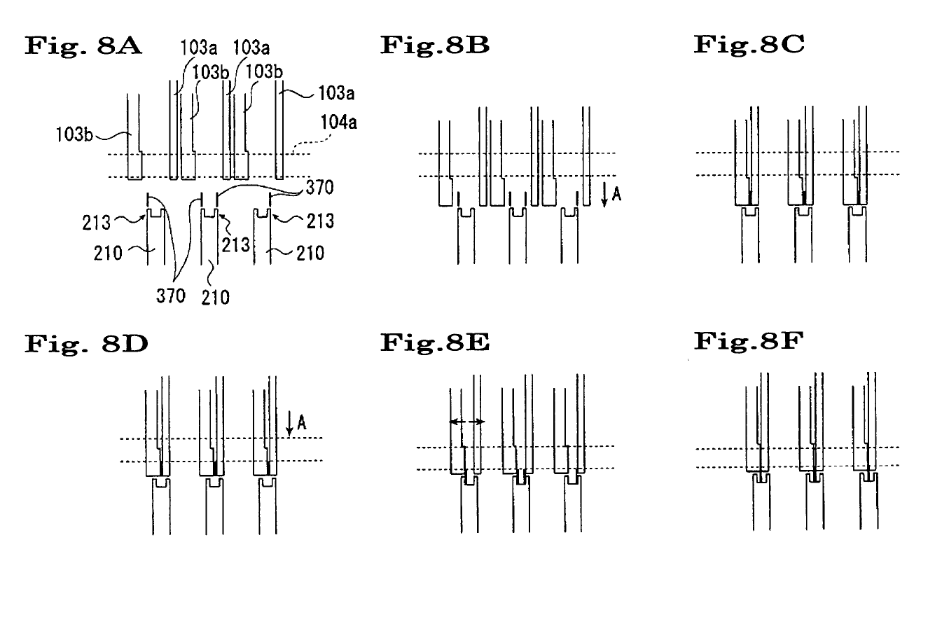

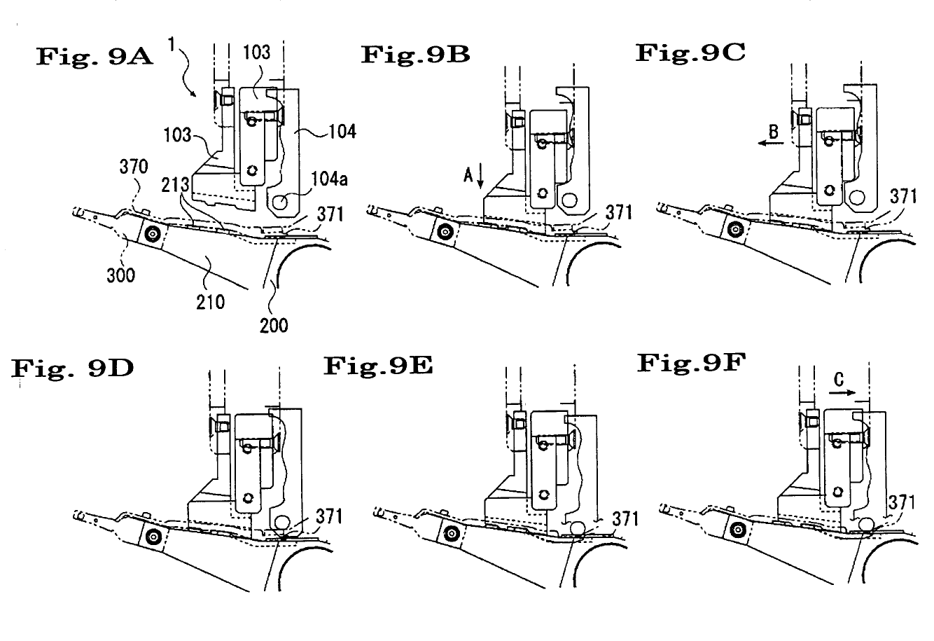

Next, operations for mounting the FPC 370 within the holding portion 213 are explained using FIGS. 8 and 9.

First, the FPC 370 is sandwiched and held from both sides in the thickness direction by the pair of members 103a and 103b. That is, for example, as shown in FIG. 8B and FIG. 9B, the pair of members 103a and 103b are in a state in which they are separated from each other, and the pair of members 103a and 103b then approach the carriage 200 side (arrow A direction) to a position where the FPC 370 should be held, after which the pair of members 103a and 103b mutually approach each other as shown in FIG. 8C to sandwich and hold the FPC 370. At this time, there are two HGAs 300 positioned in the center carriage arm 210, and therefore there are also two FPCs 370 which should be held by the holding portions 213 of the carriage arms 210. One of the pair of members 103a is formed by an elastic material, and therefore can respond to changes in the total thickness of the FPC 370 accompanying changes in weight of the sandwiched FPC 370.

Next, for example as shown in FIG. 9C, the pair of members 103a and 103b sandwiching the FPC 370 move in the direction of an arrow B of the figure and the latching hook 371 of the FPC 370 moves to a position at which it waits to be engaged with the carriage 200. At this point, the FPC 370 is moved toward the fixed end side of the HGA 300, relative to the carriage 200, and therefore deflection occurs in the FPC 370 on the HGA 300 side.

Subsequently, for example, as shown in FIG. 8D and FIG. 9D, the push-in portion 104 then moves to the carriage arm 210 side (arrow A direction) by its own weight, and stops in contact with an upper edge portion of the FPD 370, which is still sandwiched by the pair of members 103a and 103b. The push-in portion 104 is designed to have a sufficient weight such that the pressing portion 104b does not cause deformation or the like in the FPC 370, and such that it presses down on the FPC 370 when the guiding portion 103 is open.

Next, the FPC 370 recovers elastically when the sandwiched state of the FPC 370 is released, and the latching hook 371 engages with the carriage 200. That is, for example, as shown in FIG. 8E, the pair of members 103a and 103b mutually separate, the sandwiched state of the FPC 370 is released, and the FPC 370 recovers elastically from the deflected state, and extends.

Further, at this point, as shown in FIG. 9E, the push-in portion 104 lowers by its own weight so as to press onto the FPC 370 from above taking the position closest to the carriage 200. The FPC 370 is therefore pushed within the holding portion 213 by the push-in portion 104, and the latching hook 371 of the FPC 370 engages with the engaging hook 205a of the carriage 200. Note that at this point, the push-in portion 104 is pressed against the FPC 370 so as to prevent the FPC 370 from moving in a direction away from the holding portion 213.

Meanwhile, at this time, the latching hook 371 may not necessarily be in a state in which it is completely engaged with the engaging hook 205a (the FPC 370 may not necessarily recover elastically to extend fully), and only to make sure, for example as shown in FIG. 8F, the FPC 370 is once again sandwiched by the pair of members 103a and 103b, and moved to the engaging hook 205a side (arrow C direction). By doing so, The latching hook 371 becomes in a state of being completely engaged with the engaging hook 205a, even for cases in which it is assumed that it was not in a state of being completely engaged.

At this point, since one of the pair of members, the member 103a, is made from an elastic material, the pair of members is in a state of softly sandwiching the FPC 370. Therefore, the pair of members 103a and 103b slide in contact along both sides of the FPC 370 for cases in which the FPC 370 is already fully extended at a point prior to the FPC 370 being sandwiched again and moved to the engaging hook 205a side (arrow C direction).

In accordance with the FPC mounting apparatus in this embodiment mode, the FPC 370 can be automatically mounted within the holding portion 213 by the pair of members 103a and 103b, and the push-in portion 104. Further, a state in which the FPC 370 is engaged with the carriage 200 can be realized by the engaging means. The FPC 370 can therefore be mounted within the holding portion 213 in a state in which it is engaged with the carriage 200, and the FPC 370 mounted within the holding portion 213 can be prevented from falling off from the holding portion 213.

In the FPC mounting apparatus in this embodiment mode, although a structure in which the guiding portion 103 is formed to be used as the guiding means and the sandwiching means is adopted, there are no limitations on this structure. For example, a structure provided with separate guiding means and sandwiching means may also be employed. However, if the structure of the FPC mounting apparatus of this embodiment mode is used, an FPC mounting apparatus having a simple structure and capable of handling both cases in which the FPC 370 is provided with the latching hook 370, and cases in which it is not, can be provided.

Further, of the pair of members 103a and 103b structuring the guiding portion 103, one of the members 103a is made from an elastic material capable of elastic deformation, and therefore is capable of handling changes in thickness of the FPC 370, which is to be sandwiched, accompanying changes in the number of FPCs 370 sandwiched and held. Furthermore, being completely engaged with the carriage 200, the FPC 370 becomes slidable, and therefore this becomes sandwiching means capable of flexibly handling the state of the FPC 370.

Note that, in the FPC mounting apparatus in this embodiment, although a structure in which the push-in portion 104 serves both as the push-in means and the pressurizing means is adopted, there are no limitations placed on this structure, and, for example, a structure in which the push-in means and the pressurizing means are formed separately may be adopted. More preferably, by adopting a structure in which the push-in portion serves both as the push-in means and the pressurizing means, the number of component parts used can be kept small and the FPC mounting apparatus can be made into a simple structure.

Further, although a structure is used in which, of the pair of members 103a and 103b structuring the guiding portion 103, one of the members 103a is formed by an elastic material capable of elastic deformation and the other member 103b is formed by a rigid material, another structure in which both members are formed by elastic materials capable of elastic deformation may also be used.

In addition, in the first embodiment mode and the second embodiment mode, although an example of mounting the FPC 370 by using a structure in which, among the three carriage arms 210 provided to the carriage 200 in the first and the second embodiment modes, the HGA 300 is attached to the inner side surfaces of the tip portions of the carriage arms 210 at both edge portions, and the HGA 300 is positioned at both side surfaces of the carriage arm 210 located in the center, the number of the carriage arms 210, the number of the FPC 370 positions, and the like are not limited to these values. In short, it is enough that the FPC 370 provided with one or more of the HGAs 300 positioned at least on one or more of the carriage arms 210 is mounted. Therefore, the number of the pair of members 103a and 103b shown in FIGS. 5 to 8 is also not limited to that shown in the embodiment modes.

An FPC mounting apparatus can automatically mount an FPC formed integrally with the magnetic head can be within the holding portion formed in the carriage arm of the carriage by the push-in means.

In addition, the FPC can be mounted more securely by the guiding means when pushing the FPC into the holding portion using the push-in means and mounting it therein.

Further, engaging means is provided with the FPC mounting apparatus of the present invention, and therefore the FPC can be made to engage with the carrier. Work for mounting the FPC within the holding portion formed in the carriage can thus be automatically performed in a state in which the FPC is engaged with the carrier such that it is prevented from falling off form the holding portion.

In addition, the push-in means is provided, and therefore the FPC can be mounted within the holding portion more securely when the FPC is engaged to the carriage by the engaging means.

Furthermore, pressurizing means is provided, and therefore the FPC can be pressed upon in a direction so as to prevent motion in a direction away from the holding portion, and the FPC can be mounted within the holding portion more securely, when the engaging means releases a state in which the FPC is sandwiched.

The FPC can be sandwiched and released by the pair of members on the FPC mounting apparatus. At least one of the pair of members is made from the elastic material capable of elastic deformation, whereby the changes in the thickness of the FPC following the changes in the number of the FPCs to be sandwiched by the pair of members can be handled.

What is claimed is:

1. An FPC mounting apparatus for mounting an FPC, formed integrally with a magnetic head, within a holding portion formed in a carriage arm of a carriage when the magnetic head is positioned with respect to the carriage comprising:
push-in means for pushing the FPC into the holding portion and mounting it therein.

2. An FPC mounting apparatus as claimed in claim 1, further comprising:
guiding means for guiding the FPC from both sides in a thickness direction when pushing the FPC into the holding portion and mounting it therein.

3. An FPC mounting apparatus for mounting an FPC, included in a magnetic head, within a holding portion formed in a carriage and in a state of being engaged with the carriage so as to be prevented from falling off from the holding portion, when the magnetic head is positioned with respect to the carriage comprising:
engaging means for moving the FPC, relative to the carriage, to a fixing end side with respect to the magnetic head, with the FPC in a state in which it is sandwiched and held from both sides in a thickness direction, deflecting the FPC and thus moving the FPC so that an engaging portion of the FPC is in a standby position for engaging, and then releasing the FPC from its sandwiched-and-held state, thereby allowing the FPC to elastically recover and the engaging portion to engage with the carriage.

4. An FPC mounting apparatus as claimed in claim 3, further comprising:
push-in means for pushing the FPC into the holding portion and mounting it therein when the sandwiched-and-held state of the FPC is released by the engaging means.

5. An FPC mounting apparatus as claimed in claim 3, further comprising:
pressurizing means for pressing down in a direction so as to prevent the FPC from moving in a direction away from the holding portion when the sandwiched-and-held state of the FPC is released by the engaging means.

6. An FPC mounting apparatus as claimed in claim 4, further comprising:
pressurizing means for pressing down in a direction so as to prevent the FPC from moving in a direction away from the holding portion when the sandwiched-and-held state of the FPC is released by the engaging means.

7. An FPC mounting apparatus as claimed in claim 3, wherein the FPC is sandwiched and held by a pair of members for sandwiching and releasing the FPC by mutually approaching toward, and separating from, each other when the FPC is sandwiched and held from both sides in the thickness direction, and at least one of the pair of members is made of an elastic material capable of elastic deformation.

8. An FPC mounting apparatus as claimed in claim 4, wherein the FPC is sandwiched and held by a pair of members for sandwiching and releasing the FPC by mutually approaching toward, and separating from, each other when the FPC is sandwiched and held from both sides in the thickness direction, and at least one of the pair of members is made of an elastic material capable of elastic deformation.

9. An FPC mounting apparatus as claimed in claim 5, wherein the FPC is sandwiched and held by a pair of members for sandwiching and releasing the FPC by mutually approaching toward, and separating from, each other when the FPC is sandwiched and held from both sides in the thickness direction, and at least one of the pair of members is made of an elastic material capable of elastic deformation.
